(19) United States
(12) Patent Application Publication
(10) Pub. No.: US 2009/0222761 A1
(43) Pub. Date: Sep. 3, 2009

(54) COMPUTER-READABLE RECORDING MEDIUM HAVING DISPLAY SCREEN SETTING PROGRAM RECORDED THEREON, INFORMATION PROCESSING APPARATUS, AND DISPLAY SCREEN SETTING METHOD

(75) Inventor: Akiko HAYASHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/362,802

(22) Filed: Jan. 30, 2009

(30) Foreign Application Priority Data
Mar. 3, 2008 (JP) 2008-051553

(51) Int. Cl. G06F 3/048

(52) U.S. Cl. 715/781

(57) ABSTRACT

A display screen setting program allows the computer to execute the functions of acquiring the use conditions of the computer; determining set content associated with set conditions corresponding to the use conditions, on the basis of set information that is stored in a set information storage and associates the set content of the display screen with the set conditions for determining the correspondence between the set contents and the use conditions acquired by the use condition acquirer; and outputting display information for displaying the display screen on the basis of the set content.

### CROSS-REFERENCE TO RELATED APPLICATIONS

This application is based upon and claims the benefit of priority of the prior Japanese Patent Application No. 2008-51553, filed on Mar. 3, 2008, the entire contents of which are incorporated by reference herein.

### BACKGROUND

1. Field

The present invention relates to a computer-readable recording medium having a display screen setting program recorded thereon, an information processing apparatus, and a display screen setting method, and more particularly, to a computer-readable recording medium having a display screen setting program capable of changing the setting of a display screen according to the purpose of use recorded thereon, an information processing apparatus, and a display screen setting method.

2. Description of the Related Art

In recent years, computers including a GUI (graphical user interface) have come into widespread use. In many computers, an operating system (OS) generates an operating screen, and outputs image signals indicating the operating screen to a display device (monitor) connected to the computer. In this way, the user can intuitively use input devices, such as a keyboard and a mouse, while viewing the operating screen displayed on the display device, thereby easily operating the computer.

A GUI technique has been proposed which has a function of intercepting display output graphics commands of a program, correcting the commands to a desired format, and executing the correct commands. The proposed GUI technique also has a function of correcting an input data generation notice to data suitable for a computer environment defined by the program. The proposed GUI technique also has a function of appropriately correcting data exchanged between the program and a computer system.

In addition, the following technique has been proposed: information is displayed on a screen by a plurality of virtual surfaces. The virtual surfaces to be displayed are automatically switched on the basis of the use conditions (a distance between a terminal apparatus and the user or an angle formed between the terminal apparatus and the user).

Further, a technique has been proposed which moves the position of a window such that the user can easily perform operations. The technique is used when it is difficult for the user to view a screen according to the state of a display, such as defective pixels of a liquid crystal display device, the boundaries between a plurality of display devices displaying images, and a plurality of windows operated by the user.

However, a touch panel that displays images and receives information input by, for example, a dedicated pen or fingers has come into widespread use as an input device connected to the computer, in addition to a keyboard and a mouse. In this way, the user can intuitively use the input devices while viewing the operating screen displayed on the display device, thereby easily operating the computer. In this case, for example, when the touch panel is used, it is preferable that icons have a large size in order to easily touch the icons to input information.

The setting of the display screen may depend on the contents displayed on the display screen of the computer by the user. For example, if an editor is used to display text, it is difficult to read the characters when the size of the characters is excessively small, and it is difficult to display full text when the size of the characters is excessively large. Therefore it is necessary to display characters with an appropriate size. When an image is displayed by image display software, it is preferable that the image be displayed on the entire screen with a maximum size.

An image display function of the computer has been used by various users, such as consumers like an individual person or home users, and business users like a corporation or institution, in terms of convenience and compatibility. For example, a large display or a projector may be connected to the computer as an output device. The computer may be used as an image display device to display presentation images in the company or digital images captured by cameras of the home users. In this case, it is preferable that the size of the characters displayed and the size of a window in which characters or images are displayed is larger than a general size.

As described above, various kinds of input/output devices can be connected to the computer, and the optimal setting of the image display device may vary depend on the kind of input/output devices.

When the computer is used for presentation in the company, in some cases, for example, data for the presentation is made using the computer, and the computer is connected to the projector for the presentation. In addition, a home user may connect a computer, which usually is connected to a normal display device and used by one user, to a larger display device and view digital images captured while traveling with family. As such, one computer may be connected temporarily to different kinds of display devices for different purposes.

As described above, the computer can be used for various purposes. When the purpose of use is changed, the optimal setting of a display screen also varies. Therefore, the setting of the display screen of the computer is not necessarily fixed, but may be dynamically changed. On the other hand, it is difficult for an unskilled user to appropriately change the setting of the display screen according to the purpose for which it is being used. It is also complicated for a skilled user to change the setting of the display screen according to the purpose of use.

The invention has been made in order to solve the above-mentioned problems, and an object of the invention is to provide a computer-readable recording medium having a display screen setting program recorded thereon which can be displayed on the display screen with the setting according to the purpose of use, an information processing apparatus, and a display screen setting method.

### SUMMARY

According to an aspect of the invention, there is provided a display screen setting program that allows a computer to execute a process of setting a display screen for displaying an image corresponding to an input image signal. The display screen setting program allows the computer to execute the functions of: a use condition acquirer that acquires the use conditions of the computer; a set content determiner that determines set content associated with set conditions corresponding to the use conditions acquired by the use condition acquirer, on the basis of set information that is stored in a set information storage and associates the set content of the display screen with the set conditions for determining the correspondence between the set contents and the use conditions acquired by the use condition acquirer; and a display information output that outputs display information for displaying the display screen on the basis of the set content determined by the set content determiner. The use condition acquirer includes an application detector that detects the kind of application that is operated on the computer and generates information to be displayed on the display screen, and the set conditions include the kind of application detected by the application detector as determination conditions.

The above-described embodiments of the present invention are intended as examples, and all embodiments of the present invention are not limited to including the features described above.

### BRIEF DESCRIPTION OF THE DRAWINGS

FIG. 1 is a diagram illustrating the outline of an embodiment of the invention;

FIG. 2 is a diagram illustrating the hardware structure of an information processing apparatus;

FIG. 3 is a block diagram illustrating the functions of the information processing apparatus;

FIG. 4 is a diagram illustrating an example of the data structure of a set condition table;

FIG. 5 is a diagram illustrating an example of the data structure of a set content table;

FIG. 6 is a flowchart illustrating the flow of a screen setting process;

FIG. 7 is a flowchart illustrating the flow of a setting update process;

FIG. 8 is a diagram illustrating a confirmation screen;

FIG. 9 is a diagram illustrating a selection screen;

FIG. 10 is a diagram illustrating a setup screen;

FIG. 11 is a diagram illustrating a display screen;

FIG. 12 is a diagram illustrating another display screen;

FIG. 13 is a diagram illustrating still another display screen; and

FIG. 14 is a diagram illustrating yet another display screen.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereinafter, embodiments of the invention will be described with reference to the accompanying drawings.

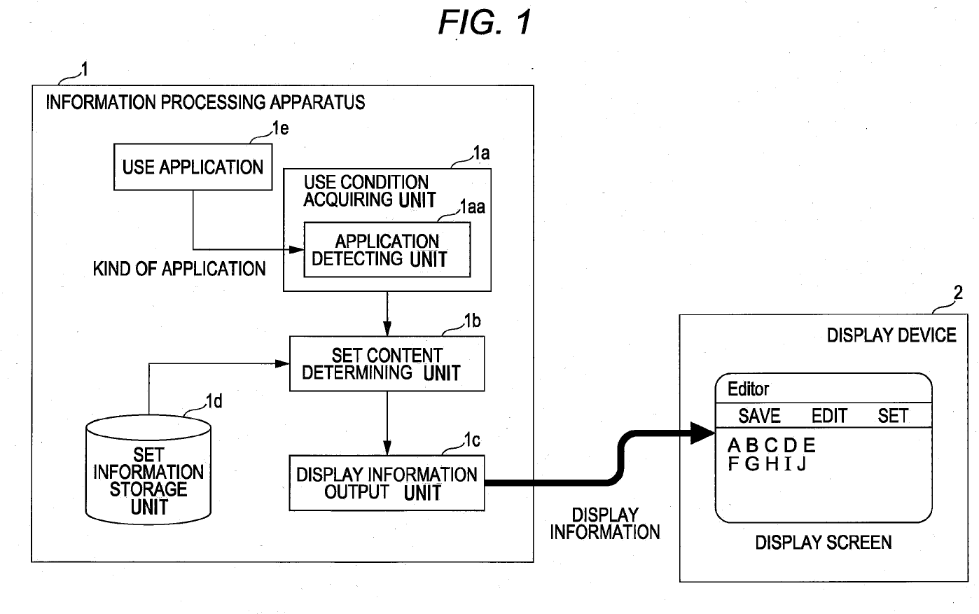

FIG. 1 is a diagram illustrating the outline of an embodiment of the invention. An information processing apparatus 1 shown in FIG. 1 is connected to a display device 2, and displays text information and image information generated by an OS and applications on the display device 2 in response to the operation of a user. A display screen setting program allows a computer to execute the functions of a use condition acquirer 1a, a set content determiner 1b, a display information output 1c, and a set information storage 1d. In this way, the information processing apparatus 1 is implemented by the display screen setting program.

In the information processing apparatus 1, a use application 1e starts up. In addition, the information processing apparatus 1 is connected to the display device 2. The use condition acquirer 1a includes an application detector 1aa.

The use condition acquirer 1a acquires the use conditions of the information processing apparatus 1 in response to the operation of the user. The use conditions acquired by the use condition acquirer 1a include, for example, the kind of use application 1e that is executed in the information processing apparatus 1 and generates information to be displayed on a display screen, and the kind of use application 1e is detected by the application detector 1aa of the use condition acquirer 1a. Specifically, the application detector 1aa detects the kind of use application 1e that is currently being executed in the information processing apparatus 1 and is currently being used by the user.

The set content determiner 1b determines set content associated with the set conditions corresponding to the use conditions acquired by the use condition acquirer 1a, on the basis of set information that is stored in the set information storage 1d. The set content determiner 1b associates the set content of the display screen with the set conditions for determining the correspondence between the use conditions and the set contents. The set conditions include as determination conditions the kind of use application 1e detected by the application detector 1aa.

The display information output 1c outputs display information for displaying the display screen on the display device 2 on the basis of the set content determined by the set content determiner 1b.

In this way, the information processing apparatus 1 can automatically change the setting of the display screen according to the purpose of use, and display a display screen with the optimal setting for the purpose of use.

Next, this embodiment will be described in detail with reference to the accompanying drawings.

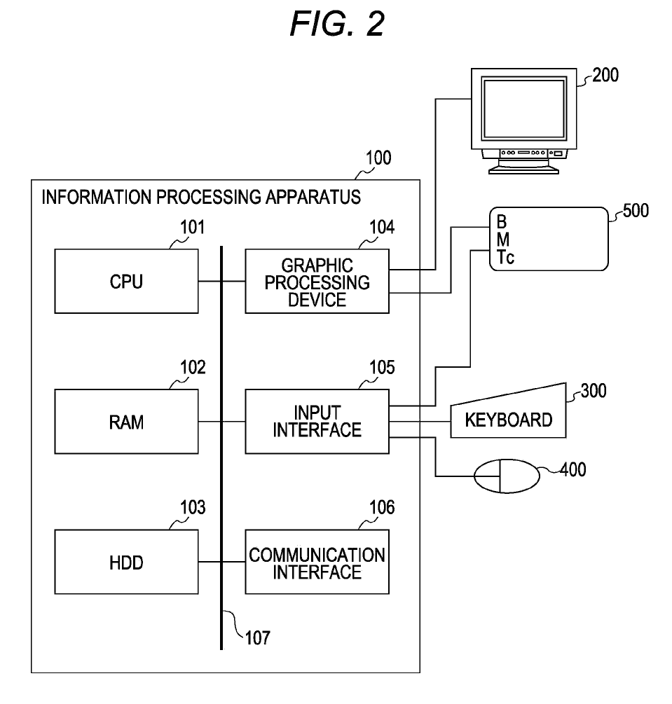

FIG. 2 is a diagram illustrating the hardware structure of an information processing apparatus.

An information processing apparatus 100 includes a CPU (central processing unit) 101, and the CPU 101 controls the overall operation of the information processing apparatus. The CPU 101 is connected to a RAM (random access memory) 102, an HDD (hard disk drive) 103, a graphic processing device 104, an input interface 105, and a communication interface 106 through a bus 107.

The RAM 102 temporarily stores at least some of the programs of an OS and the applications executed by the CPU 101. In addition, the RAM 102 stores various data required for the processing of the CPU 101.

The HDD 103 stores data treated by the OS or the applications of the information processing apparatus 100.

Display devices, such as a monitor 200, a touch panel 500, and a projector (not shown), can be connected to the graphic processing device 104. The graphic processing device 104 can display an image on the screen of the display device, such as the monitor 200, in response to instructions from the CPU 101. The graphic processing apparatus 104 and the monitor 200 are connected to each other by, for example, a serial communication cable such that they can transmit or receive control signals or image signals alternately.

Input devices, such as a keyboard 300, a mouse 400, the touch panel 500, and an operating remote controller (not shown), can be connected to the input interface 105. The input interface 105 outputs signals transmitted from the input device, such as the keyboard 300, to the CPU 101 through the bus 107.

The communication interface 106 can be connected to a network (not shown). The communication interface 106 can perform data communication with other computers through the network.

The touch panel 500 can display information corresponding to the operation of the information processing apparatus 100. The touch panel 500 detects a variation in the pressure or static electricity of a display surface provided on a front face to detect the contact of a finger or a touch pen with the display surface. For example, the user can select an icon displayed on the display surface of the touch panel to input information.

The above-mentioned hardware structure makes it possible to implement the processing functions of this embodiment.

Next, the module structure of the information processing apparatus 100 will be described.

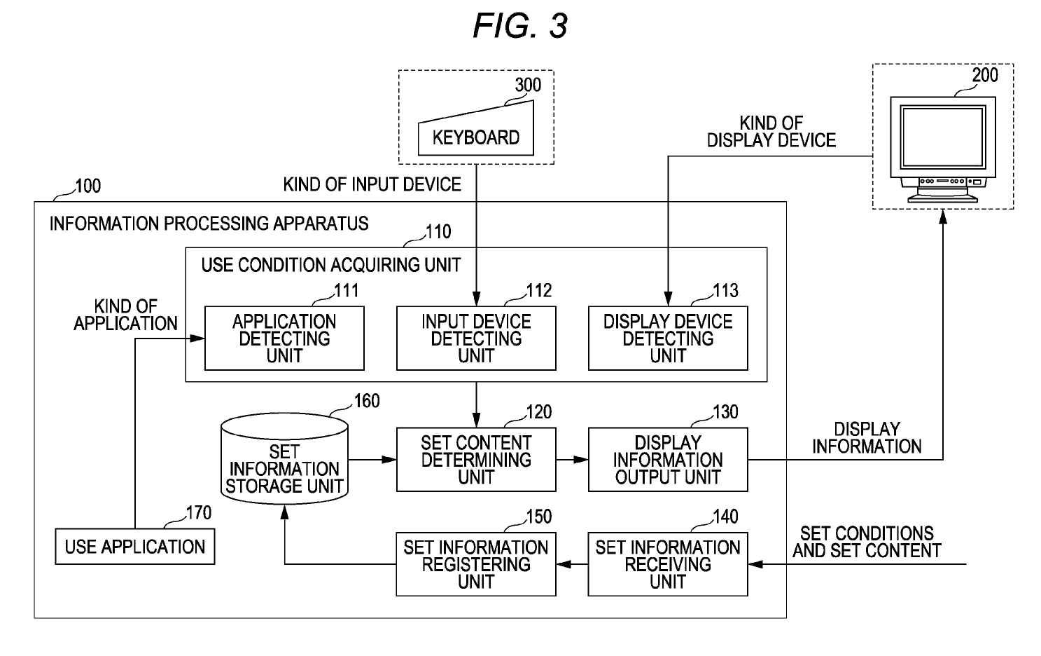

FIG. 3 is a block diagram illustrating the functions of the information processing apparatus.

The information processing apparatus 100 according to this embodiment is a computer that executes the application operated by the user and displays display content output by the application. The information processing apparatus 100 includes a use condition acquiring unit 110, a set content determining unit 120, a display information output unit 130, a set information receiving unit 140, a set information registering unit 1 50, and a set information storage unit 160, in order to display images. In addition, the use condition acquiring unit 110 includes an application detecting unit 111, an input device detecting unit 112, and a display device detecting unit 113. A computer executes a display screen setting program to implement the functions of the information processing apparatus 100.

In the information processing apparatus 100, a use application 170 starts up. The information processing apparatus 100 can be connected to a display device (see FIG. 2), such as the monitor 200, and an input device (see FIG. 2), such as the keyboard 300.

The use condition acquiring unit 11 0 acquires the use conditions of the information processing apparatus 100 in response to the operation of the user. For example, the use conditions acquired by the use condition acquiring unit 100 include the use application 170, such as a browser (not shown), that is executed in the information processing apparatus 100 and is used by the user to generate information to be displayed on a display screen, and the use application 170 is detected by the application detecting unit 111 of the use condition acquiring unit 110. In addition, the use conditions include the kind of input device, such as the keyboard 300, that is connected to the information processing apparatus 100 and outputs operation information received from the user to the information processing apparatus 100, and the kind of input device is detected by the input device detecting unit 112 of the use condition acquiring unit 110. Further, the use conditions include the kind of display device, such as the monitor 200, that receives display information output from the display information output unit 130 and displays the display screen, and the kind of display device is detected by the display device detecting unit 113 of the use condition acquiring unit 110.

The set content determining unit 120 determines set content associated with the set conditions corresponding to the use conditions acquired by the use condition acquiring unit 110, on the basis of set information that is stored in the set information storage unit 160. The set content determining unit 120 associates the set content of the display screen of the display device, such as the monitor 200, with the set conditions for determining the correspondence between the use conditions and the set contents.

The display information output unit 130 outputs display information for displaying a display screen on the display device, such as the monitor 200, on the basis of the set content determined by the set content determining unit 120.

The set information receiving unit 140 receives new set conditions and new set content input from the user. In this way, the user inputs new display screen setting information to the information processing apparatus 100.

The set information registering unit 150 stores the set conditions and the set content received by the set information receiving unit 140 in the set information storage unit 160 as set information. In this way, the user registers the new display screen setting information received by the set information receiving unit 140 to the information processing apparatus 100.

The set information storage unit 160 stores the set information associating the set content of the display screen with the set conditions for determining the correspondence between the use conditions and the set contents.

For example, the set conditions of the set information include, as determination conditions, the kind of use application 170 detected by the application detecting unit 111, the kind of input device detected by the input device detecting unit 112, and the kind of display device detected by the display device detecting unit 113.

The detected kind of use application 170 includes, for example, an editor and spreadsheet software in addition to the browser. In addition, the detected kind of input device includes, for example, the mouse 400 and the touch panel 500 shown in FIG. 2 and an operating remote controller (not shown) in addition to the keyboard 300 shown in the drawings. The detected kind of display device includes, for example, the touch panel 500 shown in FIG. 2 and a projector (not shown), in addition to the monitor 200 shown in the drawings.

For example, the set content of the set information includes, as the set content of the display screen, the size of a character displayed on the display screen, the size of a display area provided on the display screen, the size of an operating portion that is provided on the display screen and is operated by the user, and the selection of a background image.

The display device, such as the monitor 200, is connected to the information processing apparatus 100, and displays an image on the display screen on the basis of the display information output from the display information output unit 130. The display information is used to display icons on the display screen of the display device such that the user can select the icons using the input device operated by the user that outputs operation information input from the user to the information processing apparatus 100. A background image can be displayed as wallpaper on the display screen of the display device.

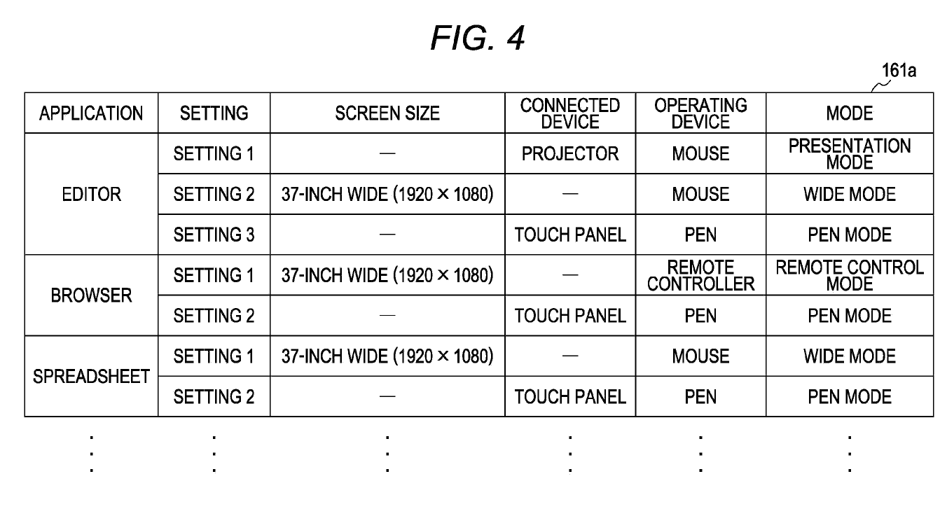

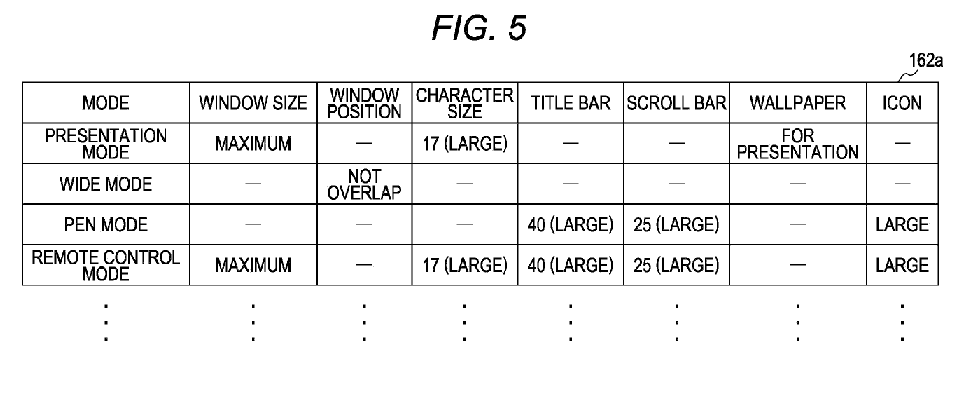

Next, tables used in the information processing apparatus according to this embodiment will be described. FIG. 4 is a diagram illustrating an example of the data structure of a set condition table. FIG. 5 is a diagram illustrating an example of the data structure of a set content table.

A set condition table 161a shown in FIG. 4 is made and managed by the information processing apparatus 100. The set condition table 161a stores set condition information indicating the set conditions that has been previously set in order to determine the mode of the display screen on the basis of the use conditions of the information processing apparatus 100 by the user. The set condition table 161a is stored in the set information storage unit 1 60.

The set condition table 161a includes an “application” field, a “setting” field, a “screen size” field, a “connected device” field, an “operating device” field, and a “mode” field. Information items arranged in the row direction in the fields are associated with each other to form the set condition information.

The application field indicates an application which is currently being used by the user and whose image is displayed on the display screen. The applications include, for example, an editor that inputs and displays text, a browser that displays a web page or an image, and spreadsheet software that performs a table calculation. When any application starts up and is then operated by the user, the application is written in the application field as the conditions.

The setting field indicates the setting of the conditions for classifying the use conditions of the information processing apparatus 100 by the user. In this embodiment, as shown in FIG. 4, a plurality of settings may correspond to one application.

The screen size field indicates the setting of the size of the display screen.

The connected device field indicates an external device connected to the information processing apparatus 100. An external display device, such as a projector or a touch panel, is generally written in the connected device field.

The operating device field indicates an external device that is connected to the information processing apparatus 100 and is operated by the user. For example, an external input device, such as a mouse, a pen for a touch panel, or an operating remote controller for moving a pointer on the display screen and performing a click operation to input information, is written in the operating device field.

The mode field indicates the name of the mode of the display screen of the information processing apparatus 100 selected by the user. Examples of the mode written in the mode field include a presentation mode suitable for presentation, a wide mode suitable when the user performs work in a wide range, a pen mode suitable when a touch panel and a touch panel pen are used as an input device, and a remote control mode suitable when an operating remote controller is used as an input device. The set content information of the set content table, which will be described below, shown in FIG. 5 is specified on the basis of the modes.

When there is a mode in which the current use conditions of the information processing apparatus 100 by the user satisfy all the conditions from the application to the operating device included in the set condition information, it is determined that the mode of the information processing apparatus 1 00 satisfies all the conditions.

The hyphen “-” in the set condition table 161a means a blank, and the blank may have any value in a determining process. That is, it is determined that the conditions represented by the hyphen are satisfied all the time regardless of the use conditions, when the mode is determined. The conditions of the set condition information are set so as not to overlap each other.

The mode of the display screen is determined by the set condition information on the basis of the use conditions of the information processing apparatus 100.

The set content table 162a shown in FIG. 5 is made and managed by the information processing apparatus 100. The set content table 162a stores set content information defining detailed set content in the mode of the display screen that is determined by the set condition table 161a on the basis of the use conditions of the information processing apparatus 100 by the user. The set content table 162a is stored in the set information storage unit 160.

The set content table 162a includes a “mode” field, a “window size” field, a “window position” field, a “character size” field, a “title bar” field, a “scroll bar” field, a “wallpaper” field, and an “icon” field. Information items arranged in the row direction in the fields are associated with each other to form the set content information.

Similar to the mode field of the set condition table 161a shown in FIG. 4, the mode field indicates the name of the mode of the display screen of the information processing apparatus 100 selected by the user. The mode determined by the set condition table 161a is specified by the mode field.

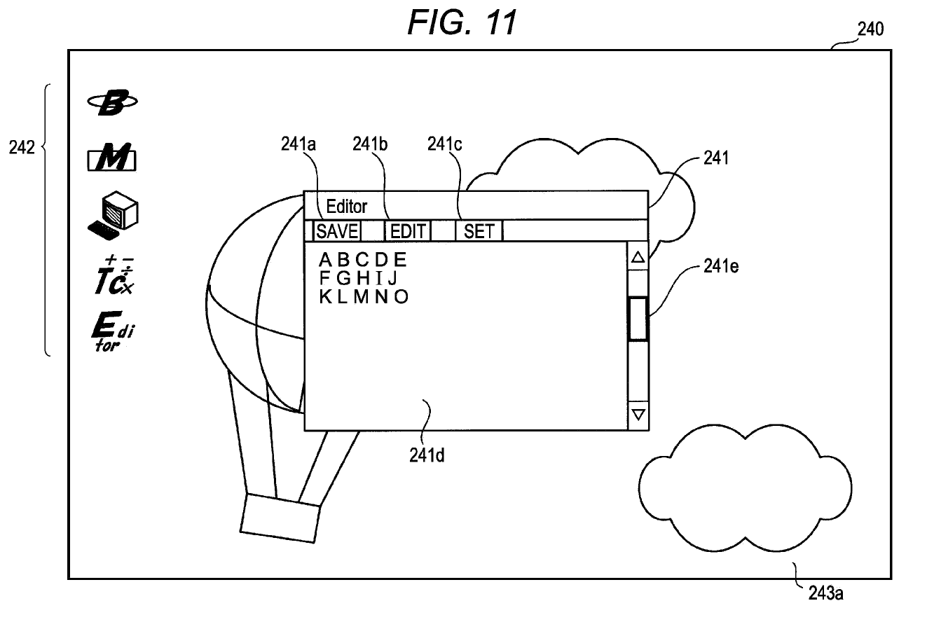

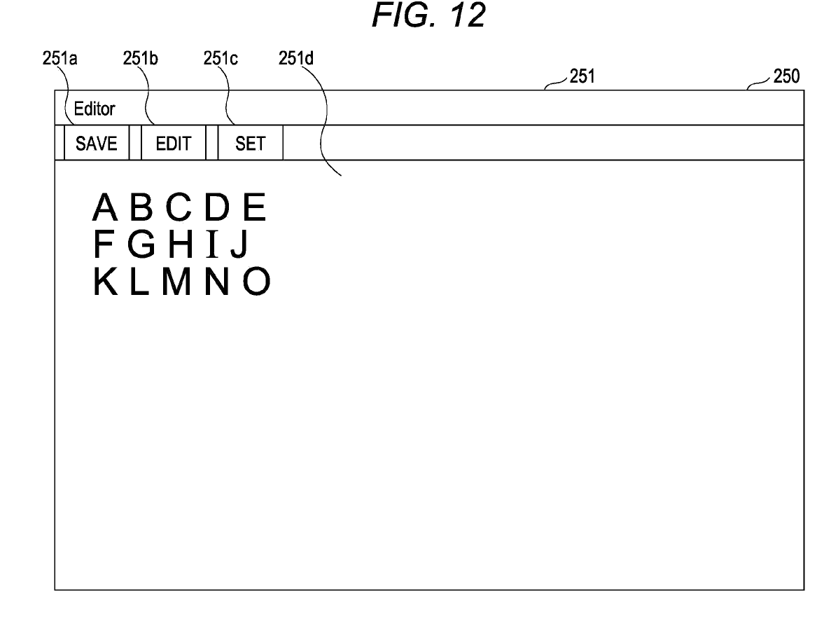

The window size field indicates the window size of an application that is set in each mode and is mainly used by the user. The setting of the window size will be described in detail below with reference to FIGS. 11 and 12.

The window position field indicates a set value of the display position of the window of the application that is set in each mode and is mainly used by the user.

The character size field indicates a set value of the size of characters displayed in the window of the application that is set in each mode and is mainly used by the user. The setting of the text size will be described in detail below with reference to FIGS. 11 and 12.

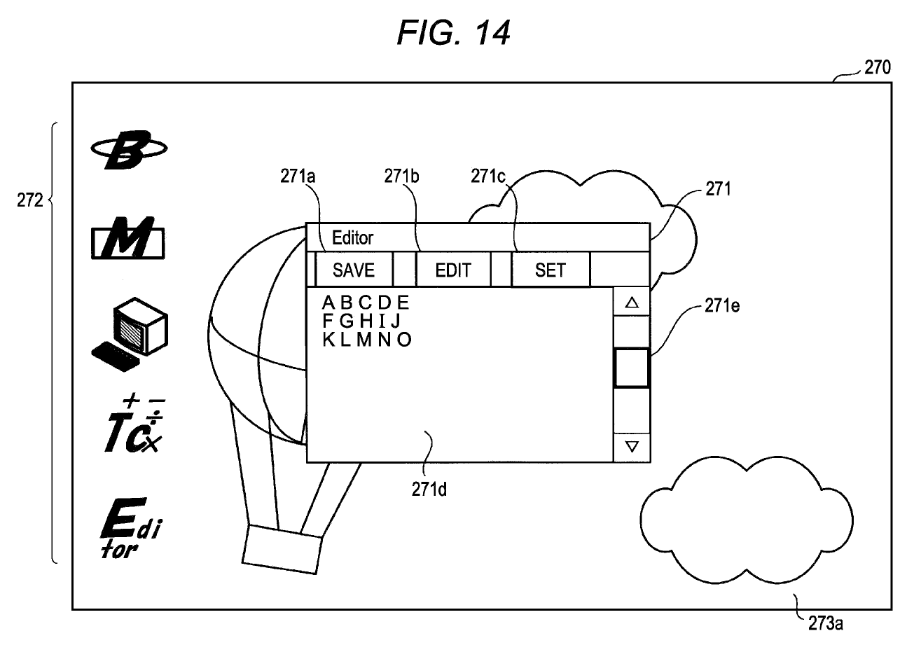

The title bar field indicates a set value of the size of an operating button provided in a title bar of the window of the application that is set in each mode and is mainly used by the user. The setting of the operating button of the title bar will be described in detail below with reference to FIGS. 11 and 14.

The scroll bar field indicates a set value of the size of a scroll bar of the window of the application that is set in each mode and is mainly used by the user. The scroll bar will be described in detail below with reference to FIGS. 11 and 14.

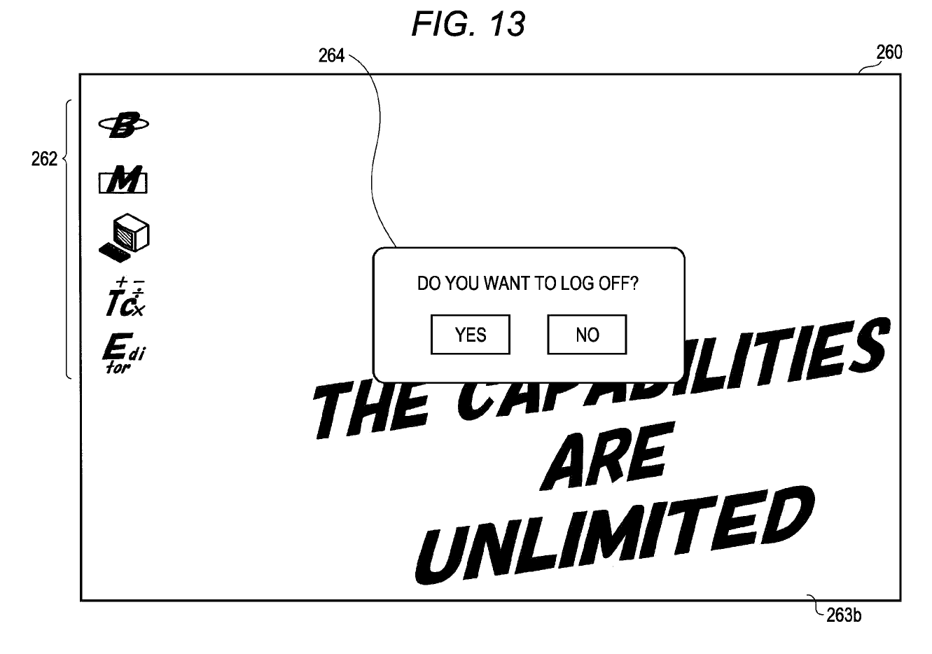

The wallpaper field indicates the setting of wallpaper, which is the background of the display screen, set in each mode. The setting of the wallpaper will be described in detail below with reference to FIGS. 11 and 13.

The icon field indicates a set value of the size of an icon that is set in each mode and is displayed on the display screen. The setting of the icon will be described in detail below with reference to FIGS. 11 and 14.

The hyphen “-” in the set content table 162a means a blank, and indicates that the previous set content is not changed during the setting of the display screen. That is, when the display screen is set in each mode, the setting of an item represented by the hyphen is not changed during the setting of the display screen.

The set content information makes it possible to specify the setting of a display screen corresponding to the mode determined on the basis of the set condition information.

Next, the process of the information processing apparatus according to this embodiment will be described. First, a screen setting process of acquiring the use conditions of the information processing apparatus 100 and setting the display screen according to the use conditions will be described.

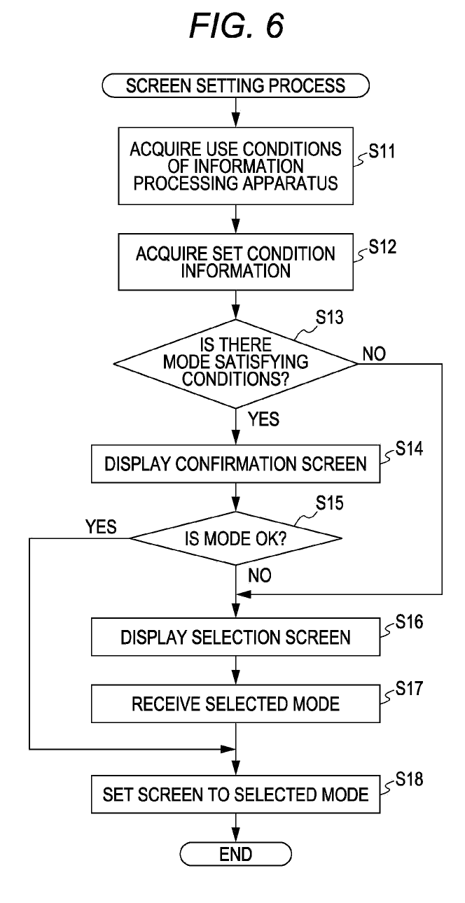

FIG. 6 is a flowchart illustrating the flow of the screen setting process.

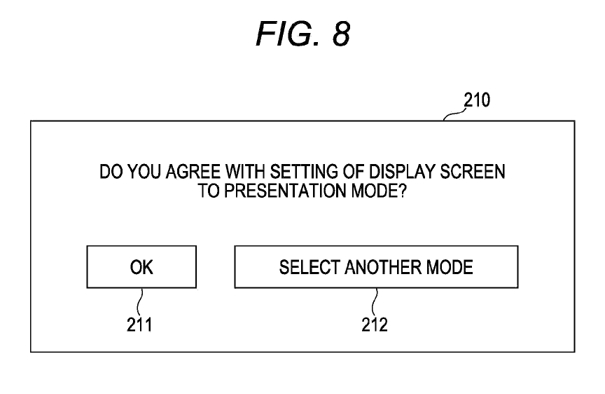

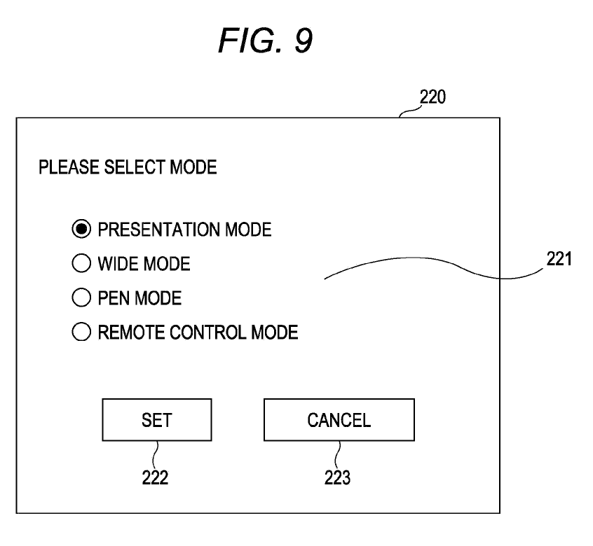

The information processing apparatus 100 according to this embodiment performs the screen setting process to acquire the use conditions of the information processing apparatus 100, determine a mode corresponding to the acquired use conditions reflecting user's intention, and set the display screen to the determined mode. The information processing apparatus 100 performs the screen setting process all the time or at a predetermined interval, in order to monitor a variation in the use conditions of the information processing apparatus 100 consistently. Next, the screen setting process will be described.

[Operation S11] The information processing apparatus 100 acquires the use conditions of the information processing apparatus 100. Specifically, the use conditions include information corresponding to the items of the set condition table 161a shown in FIG. 4 (for example, the application operated by the user, the size of the display screen, and an input/output device connected to the information processing apparatus).

[Operation S12] The information processing apparatus 100 acquires all the set condition information items shown in FIG. 4 from the set information storage unit 160.

[Operation S13] The information processing apparatus 100 compares the use conditions of the information processing apparatus 100 acquired in Operation S11 with all the set condition information items acquired in Operation S12 to determine whether to satisfy the conditions of the set condition information. The information processing apparatus 100 then determines whether there is a mode satisfying the conditions on the basis of the determination result. If it is determined that there is a mode satisfying the conditions, the information processing apparatus 100 proceeds to Operation S14. On the other hand, if it is determined that there is no mode satisfying the conditions, the information processing apparatus 100 proceeds to Operation S16.

[Operation S14] The information processing apparatus 100 displays on the display screen a confirmation screen for allowing the user to confirm that the display screen is set to the mode which is determined to satisfy the conditions in Operation S13. The confirmation screen will be described in detail below with reference to FIG. 8.

[Operation S15] The information processing apparatus 100 receives the confirmation result of the user input from the confirmation screen displayed in Operation S14. Then, the information processing apparatus 100 determines whether the user agrees with the setting of the display screen to the mode which is determined to satisfy the conditions in Operation S13, on the basis of the confirmation result of the user through the confirmation screen displayed in Operation S14. If it is determined that the user agrees with the setting of the display screen to the mode, the information processing apparatus 100 proceeds to Operation S18. On the other hand, if it is determined that the user does not agree with the setting of the display screen to the mode, the information processing apparatus 100 proceeds to Operation S16.

[Operation S16] The information processing apparatus 100 displays a selection screen for allowing the user to select a mode on the display screen. The selection screen will be described in detail below with reference to FIG. 9.

[Operation S17] The information processing apparatus 100 receives the mode selection result of the user input from the selection screen displayed in Operation S16.

[Operation S18] The information processing apparatus 100 acquires the set content information shown in FIG. 5 from the set information storage unit 160. The information processing apparatus 100 then sets the display screen to the mode that is confirmed by the user input in Operation S15 or the mode that is selected by the user input in Operation S17. Then, the information processing apparatus 100 ends the process.

Next, a setting update process of adding a new mode to the setting of the display screen of the information processing apparatus 100 or correcting the setting of the mode to update the set condition information and the set content information will be described.

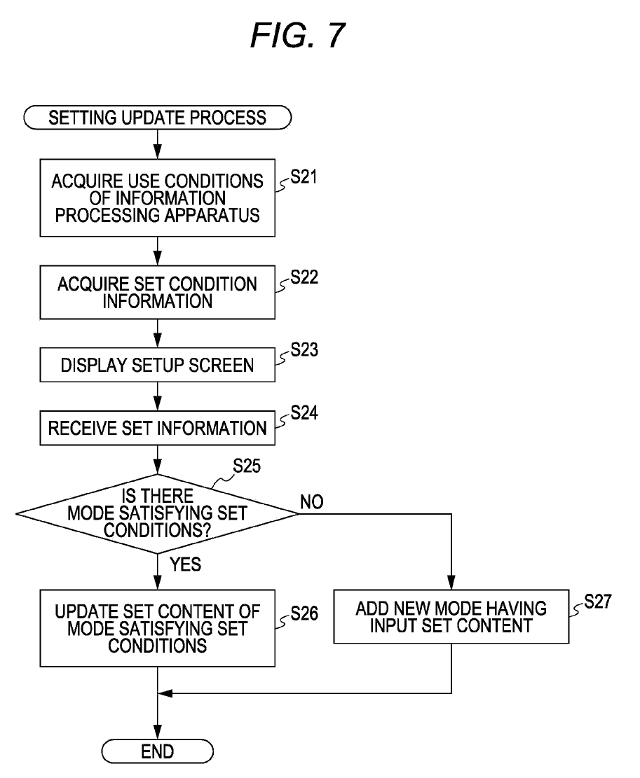

FIG. 7 is a flowchart illustrating the flow of the setting update process.

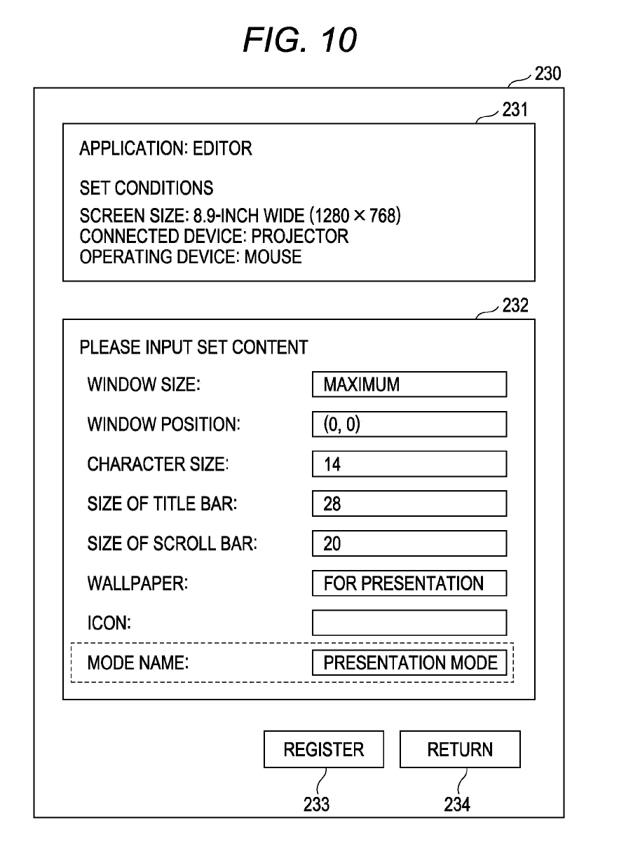

In the setting update process, the information processing apparatus 100 according to this embodiment receives the set conditions and the set content input from the user and compares the input set conditions with the set condition information. If there is a mode in which the input content is identical to the set conditions, the information processing apparatus 100 updates the set content of the mode with the input set conditions and the input set content. On the other hand, if there is no mode in which the input content is identical to the set conditions, the information processing apparatus 100 adds a new mode with the current set conditions (that is, the use conditions) and the input set content. When the user wishes to input new set conditions and set content, the setting update process is performed on the operation of the user. That is, for example, when the user operates a setting input button (not shown), the information processing apparatus 100 starts the setting update process. Next, the setting update process will be described.

[Operation S21] The information processing apparatus 100 acquires the use conditions of the information processing apparatus 100. Specifically, the use conditions include information corresponding to the items of the set condition table 161a shown in FIG. 4 (for example, the application operated by the user, the size of the display screen, and an input/output device connected to the information processing apparatus).

[Operation S22] The information processing apparatus 100 acquires all the set condition information items shown in FIG. 4 from the set information storage unit 160.

[Operation S23] The information processing apparatus 100 displays, on the display screen, a setup screen for allowing the user to input information for setting the mode of the display screen. The setup screen will be described in detail below with reference to FIG. 10.

[Operation S24] The information processing apparatus 100 receives the set conditions and the set content input by the user through the setup screen displayed in Operation S23.

[Operation S25] The information processing apparatus 100 compares the set conditions input from the user in Operation S24 with all the set condition information items acquired in Operation S22, and determines whether the conditions are identical to each other. Then, the information processing apparatus 100 determines whether there is a mode in which the conditions are identical to each other on the basis of the determination result. If it is determined that there is a mode in which the conditions are identical to each other, the information processing apparatus 100 proceeds to Operation S26. On the other hand, if it is determined that there is no mode in which the conditions are identical to each other, the information processing apparatus 100 proceeds to Operation S27.

[Operation S26] The information processing apparatus 100 updates the set content of the set content information of the mode that is determined to satisfy the conditions in Operation S25 with the set content input from the user in Operation S24. Then, the information processing apparatus 100 ends the process.

[Operation S27] The information processing apparatus 100 uses the use conditions acquired in Operation S21 as the set conditions, creates a new mode based on the set content input from the user in Operation S24, and adds the new mode to the set condition information and the set content information, thereby completing update. Then, the information processing apparatus ends the process.

Next, a setting operating screen displayed on the display screen of the information processing apparatus according to this embodiment will be described. The setting operating screen is displayed on a display screen of a display device, such as the monitor 200, the touch panel 500, or a projector (not shown), and is used for the screen setting process and the setting update process. Examples of the setting operation screen include a confirmation screen, a selection screen, and a setup screen, which will be described below. These setting operation screens are displayed as pop-up windows on the display screen, if necessary.

FIG. 8 is a diagram illustrating the confirmation screen. A confirmation screen 210 shown in FIG. 8 is used to allow the user to confirm whether to change the setting of the screen to the mode that is determined to satisfy the set conditions by the screen setting process (see FIG. 6).

The confirmation screen 210 includes a confirmation button 211 and a change button 212.

A message asking whether to set the display screen to the mode that is determined by the screen setting process is displayed on the confirmation screen 210.

The confirmation button 211 is used for the user to agree with the setting of the display screen to the mode that is determined by the screen setting process.

The change button 212 is used for the user to select another mode without agreeing with the setting of the display screen to the mode that is determined by the screen setting process.

When the confirmation button 211 is operated, the information processing apparatus 100 determines that the user agrees with the setting of the display screen to the determined mode, and proceeds to Operation S15 in the screen setting process. When the change button 212 is operated, the information processing apparatus 100 determines that the user does not agree with the setting of the display screen to the determined mode, and performs the same process. The display screen may be changed and the setting operating screen may be displayed on the entire display area of the display screen, if necessary. Alternatively, the setting operating screen may be displayed on the display screen all the time by a gadget.

FIG. 9 is a diagram illustrating the selection screen. A selection screen 220 shown in FIG. 9 is used for the user to select a mode to be set when the user does not agree with the setting of the display screen to the mode determined by the screen setting process (see FIG. 6) on the confirmation screen.

The selection screen 220 includes a selection area 221, a setting button 222, and a cancel button 223.

A list of the modes to which the setting of the display screen can be changed and a radio button for selecting one of the modes are displayed on the selection area 221.

The setting button 222 is for changing the setting of the display screen to the mode selected by the radio button of the selection area 221.

The cancel button 223 is for canceling the change in the setting of the display screen and interrupting the screen setting process.

When the radio button of the selection area 221 and the setup button 222 are operated, the information processing apparatus 100 determines that the user agrees with a change in the setting of the display screen to the mode selected by the radio button, and proceeds to Operation S17 in the screen setting process. When the cancel button 223 is operated, the information processing apparatus 100 determines that the user does not agree with the change in the setting of the display screen, and interrupts the screen setting process.

FIG. 10 is a diagram illustrating the setup screen. A setup screen 230 shown in FIG. 10 is for allowing the user to input set content in the setup update process (see FIG. 7).

The setup screen 230 includes a condition display area 231, a setup area 232, a registration button 233, and a return button 234.

The current use conditions of the display screen are displayed as the set conditions in the condition display area 231. The current use conditions of the information processing apparatus 100 acquired in Operation S21 of the setting update process is displayed in the condition display area 231. When the user operates the registration button 233 as described below, a mode having the use conditions as the set conditions is updated or added.

The set content input by the user is displayed in the setup area 232. Specifically, a message requiring the input of new set content related to the display screen is displayed in the setup area 232. The user can use the setup area 232 to input set content. In addition, the user can leave the field that is not specified by the set content blank. In this way, when the setting of the display screen is changed by the set content information that is updated or added on the basis of the set content including the blanks, the previous set content is maintained without changing the setting of the item corresponding to the information.

The registration button 233 is for updating or adding the mode having the use conditions displayed in the condition display area 231 as the set conditions and the set content input to the setup area.

The return button 234 is for canceling the input of the set content and for interrupting the setting update process.

When set content is input to the setup area 232, the information processing apparatus 100 proceeds to Operation S24 in the setting update process. When the return button 234 is operated, the information processing apparatus 100 determines that the user does not input mode setting content, and interrupts the setting update process.

The user may delete the values of the set conditions that are not required for setting among the set conditions displayed in the condition display area 231 to leave the items of the set conditions blank. In this way, in the set condition information updated or added on the basis of the unnecessary set conditions including the blanks, the unnecessary set conditions are excluded from determination targets, and it is determined that the unnecessary set conditions are satisfied all the time, regardless of the use conditions.

Next, the display screen displayed on the display device of the information processing apparatus according to this embodiment will be described.

FIGS. 11, 12, 13, and 14 are diagrams illustrating display screens.

Display screens 240, 250, 260, and 270 respectively shown in FIGS. 11, 12, 13, and 14 are displayed on the display screen of the display devices, such as the monitor 200 (see FIG. 2), the touch panel 500 (see FIG. 2), and a projector (not shown), connected to the information processing apparatus 100, and the output of the application used by the user is displayed on the display screens.

An editor window 241, icons 242, and a wallpaper A243a are displayed on the display screen 240 shown in FIG. 11. The display screen 240 is an example of the display screen displayed on the monitor 200 (see FIG. 2) connected to the information processing apparatus 100 when the user operates the mouse 400 (see FIG. 2) to use an editor for creating text.

Information related to an application operated by the user to input characters to create text is displayed on the editor window 241. The editor window 241 includes operating buttons 241a, 241b, and 241c, a text display area 241d, and a scroll bar 241e.

The user operates the editor using the operating buttons 241a, 241b, and 241c. The user operates, for example, the mouse 400 to move a pointer to the operating buttons 241a, 241b, and 241c, and clicks a button of the mouse 400 to operate the editor.

The user inputs characters to create text in the text display area 241d, and the input text is displayed in the text display area.

When it is difficult to display all text in the text display area 241d of the editor window 241, the user uses the scroll bar 241e to scroll the text in the vertical direction. The user uses, for example, the mouse 400 to move the pointer to the scroll bar 241e and drags the scroll bar using the mouse 400 upward or downward to scroll the text display area 241d upward or downward.

The icons 242 are for operating the information processing apparatus 100 and applications operated by the information processing apparatus 100. The user uses, for example, the mouse 400 to move the pointer to each of the icons 242, and clicks a button of the mouse 400 to operate the information processing apparatus 100 and the applications operated by the information processing apparatus 100.

The wallpaper A243a is wallpaper as it is called, and is an image that is displayed as the background of the display screen 240.

As described above, the display screen 240 is an example of the display screen displayed on the monitor 200 when the user operates the mouse 400 to use the editor to create text. In this case, in the information processing apparatus 100 according to this embodiment, a display screen that is suitable for the user to individually input text, which is the most common content, is set on the basis of the set condition information and the set content information.

An editor window 251 is displayed with the maximum size in the display screen 250 shown in FIG. 12. The display screen 250 is an example of the display screen displayed on a projector (not shown) connected to the information processing apparatus 100 when the user operates the mouse 400 (see FIG. 2) to use the editor to display text.

Similar to the editor window shown in FIG. 11, information related to an application operated by the user to input characters to create text is displayed on the editor window 251. The editor window 251 includes operating buttons 251a, 251b, and 251c, and a text display area 251d.

As described above, the display screen 250 is an example of the image projected onto a screen (not shown) of the projector when the user operates the mouse 400 to use the editor to input text. In this case, in the information processing apparatus 100 according to this embodiment, a display screen that is suitable to display text on the display screen of the projector such that other persons view the text is set on the basis of the set condition information and the set content information. Specifically, the size of the characters displayed in the text display area 251d of the display screen 250 is larger than that of the characters displayed in the text display area 241d of the display screen 240 shown in FIG. 11.

On the display screen 250, icons and wallpaper are concealed by the editor window 251. The concealed icons and wallpaper will be described below with reference to FIG. 13.

Icons 262, a wallpaper B263b, and an end window 264 are displayed on the display screen 260 shown in FIG. 13. The display screen 260 is an example of the display screen displayed on a projector (not shown) connected to the information processing apparatus 100 when the user uses the mouse 400 (see FIG. 2) to log off the information processing apparatus 100 after the editor is closed.

The end window 264 is used for the user to log off the information processing apparatus 100.

As described above, the display screen 260 is an example of the display screen when the information processing apparatus is connected to the projector and the user ends the use of the editor. In this case, in the information processing apparatus 100 according to this embodiment, a display screen that is suitable to display icons and wallpaper as well as the editor shown in FIG. 12 on the display screen of the projector such that other persons view them is set on the basis of the set condition information and the set content information. Specifically, the size of the icons 262 displayed on the display screen 260 is equal to that of the icons 242 displayed on the display screen 240 shown in FIG. 11, but the wallpaper B263b displayed on the display screen 260 is different from the wallpaper A263a displayed on the display screen 240 shown in FIG. 11. Therefore, the display screen 260 is suitable for presentation.

An editor window 271, icons 272, and a wallpaper A273a are displayed on the display screen 270 shown in FIG. 14. The display screen 270 is an example of the display screen displayed on the touch panel 500 (see FIG. 2) connected to the information processing apparatus 100 when the user operates the mouse 400 (see FIG. 2) to use the editor to input text.

Similar to the editor window shown in FIG. 11, information related to an application operated by the user to input characters to create text is displayed on the editor window 271. The editor window 271 includes operating buttons 271a, 271b, and 271c, a text display area 271d, and a scroll bar 271e.

As described above, the display screen 270 is an example of the display screen displayed on the touch panel 500 when the user uses a touch panel pen (not shown) to operate the editor. In this case, in the information processing apparatus 100 according to this embodiment, a display screen that is suitable for the user to view text displayed on the touch panel 500 and use the touch panel pen to operate the icons 272, the operating buttons 271a, 271b, and 271c, and the scroll bar 271e is set on the basis of the set condition information and the set content information.

Specifically, the size of the characters displayed in the text display area 271d of the display screen 270 is set to a general value, and general wallpaper is set as the wallpaper A243a. However, the size of the operating buttons 271a, 271b, and 271c of the editor window 271 is larger than that of the operating buttons 241a, 241b, and 241c of the display screen 240 shown in FIG. 11. In addition, the size of the scroll bar 271e is larger than that of the scroll bar 241e of the display screen 240 shown in FIG. 11. The size of the icons 272 is larger than that of the icons 242 of the display screen 240 shown in FIG. 11.

The information processing apparatus 100 according to this embodiment sets the size of the characters displayed on the screen on the basis of the use conditions of the application that is currently being used by the user.

It is considered that the setting of the display screen that is easily viewed by the user depends on the state of the user of the information processing apparatus 100 (for example, a case in which one person views the display screen, a case in which a plurality of persons view the display screen, a case in which the user gets a near view of the display screen, a case in which the user views the display screen from a distance, a case in which the user performs a delicate operation, and a case in which the user views the display screen for a long time).

However, it is complicated to manually change the setting of the display screen according to the use conditions. In particular, it is not easy for an unskilled user to change the setting of the display screen.

Therefore, in this embodiment, ‘the set conditions’ corresponding to ‘the use conditions’ are prepared in advance, and the setting of the display screen is automatically changed in correspondence with the use conditions. In this way, it is possible to rapidly and simply change the setting of the display screen to the optimal mode.

Specifically, the settings of the display screen, such as the size of the characters displayed on the screen, the size of icons, the size and type of a mouse pointer, the display position of a window, the resolution of the screen, and wallpaper displayed as a background, are appropriately set on the basis of information, such as the use conditions (for example, the connection of an external monitor or projector, the size of a display unit of the monitor, and input devices such as a keyboard and an operating remote controller) and the application that is currently being used by the user.

As described above, according to the information processing apparatus 100 of this embodiment, the setting of the display screen is automatically changed according to the purpose of use. Therefore, it is possible to change the setting of the display screen to a mode suitable for the purpose of use.

In this way, it is possible to provide the information processing apparatus 100 capable of easily setting an optimal display screen corresponding to the use conditions to all users including individual users and corporation users.

Although the computer readable recording medium having the display screen setting program recorded thereon, the information processing apparatus, and the display screen setting method according to the embodiments of the invention have been described above with reference to the drawings, the above just shows the principle of the invention. The invention is not limited to the above-mentioned structure and applications, but it will be understood by those skilled in the art that various modifications and changes of the invention can be made without departing from the scope and spirit of the invention. The scope of the invention is defined by the appended claims rather than by the description preceding them, and all changes and modifications that fall within meets and bounds of the claims, or equivalences of such meets and bounds are therefore intended to be embraced by the claims. The structure of each component can be replaced with any structure having the same function. In addition, any other structures or processes may be added to the invention. Further, two or more structures (characteristics) of the above-described embodiments of the invention may be combined with each other.

The processing functions are implemented by a computer. In this case, a program having the process contents of all the functions of the information processing apparatus 100 described therein is provided. The computer executes the program to implement the processing functions on the computer.

The program having the process contents described therein may be recorded on a computer-readable recording medium. Examples of the computer-readable recording medium include a magnetic recording device, an optical disk, a magneto-optical recording medium, and a semiconductor memory. Examples of the magnetic recording device include an HDD, a flexible disk (FD), and a magnetic tape (MT). Examples of the optical disk include a DVD (digital versatile disc), a DVD-RAM, a CD-ROM (compact disc-read only memory), and a CD-R (recordable)/RW (rewritable). Examples of the magneto-optical recording medium include a MO (magneto-optical disk).

The program is distributed in the form of, for example, a portable recording medium having the program recorded thereon, such as a DVD or a CD-ROM. In addition, the program may be stored in a server computer and the program may be transmitted from the server computer to other computers through the network.

The computer executing the program stores the program recorded on, for example, a portable recording medium or the program transmitted from the server computer in its own storage device. Then, the computer reads out the program from its own storage device, and performs a process according to the program. The computer may directly read out the program from a portable recording medium, and perform a process according to the program. Whenever a program is transmitted from the server computer, the computer may sequentially perform processes according to the received programs.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer-readable recording medium having a display screen setting program recorded thereon that allows a computer to execute a process of setting a display screen for displaying an image corresponding to an input image signal,
wherein the display screen setting program allows the computer to execute the functions of:
a use condition acquirer that acquires the use conditions of the computer;
a set content determiner that determines set content associated with set conditions corresponding to the use conditions acquired by the use condition acquirer, on the basis of set information that is stored in a set information storage and associates the set content of the display screen with the set conditions for determining the correspondence between the set contents and the use conditions acquired by the use condition acquirer; and
a display information output that outputs display information for displaying the display screen on the basis of the set content determined by the set content determiner,
wherein the use condition acquirer includes an application detector that detects the kind of application that is operated on the computer and generates information to be displayed on the display screen, and
the set conditions include the kind of application detected by the application detector as determination conditions.

2. The recording medium according to claim 1,
wherein the use condition acquirer includes an input device detector that detects the kind of input device which is connected to the computer and outputs operation information based on the operation of the user to the computer, and
the set conditions include the kind of input device connected to the computer as the determination conditions.

3. The recording medium according to claim 1,
wherein the use condition acquirer includes a display device detector that detects the kind of display device which is connected to the computer, receives the display information output from the display information output, and displays the display screen, and
the set conditions include the kind of display device connected to the computer as the determination conditions.

4. The recording medium according to claim 1,
wherein the display screen setting program allows the computer to further execute the functions of:
a set information receiver that receives new set conditions and new set content; and
a set information register that stores the new set conditions and the new set content received by the set information receiver in the set information storage as the set information.

5. The recording medium according to claim 1,
wherein the set content includes the size of characters displayed on the display screen.

6. The recording medium according to claim 1,
wherein the set content includes the size of a display area of the display screen.

7. The recording medium according to claim 1,
wherein the display information is used to display icons on the display screen such that the user can select the icons using the input device that outputs operation information based on the operation of the user to the computer, and
the set content includes the size of an operating portion that is provided on the display screen and is operated by the user.

8. The recording medium according to claim 1,
wherein the display screen can display a background image that is displayed as a background, and
the set content includes the selection of the background image.

9. An information processing apparatus for setting a display screen that displays an image corresponding to an input image signal, the information processing apparatus comprising:
a set information storage that stores set information which associates the set content of the display screen with set conditions for determining the correspondence between the set contents and the use conditions of the information processing apparatus;
a use condition acquirer that acquires the use conditions of the information processing apparatus;
a set content determiner that determines the set content associated with the set conditions corresponding to the use conditions acquired by the use condition acquirer, on the basis of the set information that is stored in the set information storage and associates the set content of the display screen with the set conditions for determining the correspondence between the set contents and the use conditions acquired by the use condition acquirer; and
a display information output that outputs display information for displaying the display screen on the basis of the set content determined by the set content determiner,
wherein the use condition acquirer includes an application detector that detects the kind of application that is operated on the information processing apparatus and generates information to be displayed on the display screen, and
the set conditions include the kind of application detected by the application detector as determination conditions.

10. A method of setting a display screen that displays an image corresponding to an image signal input from a computer, the method comprising:
acquiring a use condition of the computer;
detecting the kind of application that is operated on the computer;
generating information to be displayed on the display screen;
determining a set content of the display screen associated with set conditions corresponding to the use conditions;
associating the set content of the display screen with the set conditions for determining the correspondence between the set contents and the use conditions on the basis of the set information; and
outputting display information for displaying the display screen on the basis of the set content;
wherein the set conditions include the kind of application detected as determination conditions.
